(19) United States
(12) Patent Application Publication
(10) Pub. No.: US 2026/0286582 A1
(43) Pub. Date: Sep. 24, 2026

(54) DEVICE FOR FORMING AND WEAVING A NON-METAL COMPOSITE REINFORCING MESH

(71) Applicant: LIMITED LIABILITY COMPANY "COMPOSITE GROUP CHELYABINSK", Chelyabinsk (RU)

(72) Inventor: Oleg Yurievich BELIAEV, Chelyabinsk (RU)

(21) Appl. No.: 18/880,297

(22) PCT Filed: Dec. 14, 2022
(86) PCT No.: PCT/RU2022/000370

§ 371 Date: Dec. 31, 2024

(30) Foreign Application Priority Data
Jul. 10, 2022 (RU) 2022118777

(51) Int. Cl. D03D 41/00; D03D 51/02

(52) U.S. Cl. CPC D03D 41/00; D03D 51/02; D10B 2505/02

(57) ABSTRACT

The invention describes equipment used in production lines for manufacturing non-metallic reinforcement mesh. The technical result is an enhanced quality of produced non-metallic reinforcing mesh due to an equal number of twists of longitudinal strands of roving that are made around a transverse rod strictly perpendicular to the longitudinal rods. The device for forming and weaving non-metallic reinforcing mesh contains an electric drive and the following assembly parts mounted on a frame: a transverse rod feeding unit, a unit for feeding a longitudinal bundle of roving that includes gears with holes designed to divide the longitudinal bundle of roving into two longitudinal strands and intertwist them, and a cutting unit for the transverse rod. The device for forming and weaving non-metallic reinforcement mesh is equipped with a toothed rack and a guide comb that is located across the frame. The guide comb can move along the axis (tilts along the longitudinal rods) and is equipped with a longitudinal groove that accommodates the transverse rod. The toothed rack can reciprocate to drive the gears. A device for aligning transverse rods is positioned after the guide comb down the mesh movement.

The invention describes equipment used in production lines for manufacturing non-metallic reinforcing mesh which is used, in particular to reinforce masonry, brickwork and concrete products.

The patent RU 2714060 describes a unit for forming and weaving mesh which is a group of matrices that are kinematically connected with each other, are equipped with a drive and are oriented transversely to longitudinal strands of the mesh. The matrices are gears that are mounted on a frame with longitudinally oriented shafts, the gears interlock with each other and are connected to an electric motor that causes the gears to rotate. The matrices contain channels directing roving strands that form, when the matrices are rotating, longitudinal roving rods. The longitudinal rods are formed from intertwining adjacent longitudinal strands of roving, thus mesh cells are formed when the longitudinal rods are being interlaced with a cured transverse rod. The unit for forming and weaving mesh contains a module for laying a cured transverse rod made of roving, the module is transverse to the longitudinal axes of matrices rotation.

The disadvantage of the mentioned device is the low quality of the final product due to the nonuniformity of physical and mechanical characteristics of the entire web of the finished non-metallic reinforcement mesh due to the fact that it is impossible to create mesh cells of equal size.

A unit for forming and weaving non-metallic reinforcement mesh of a production line for the manufacture of non-metallic reinforcement mesh described by the patent RU 173663 becomes the closest solution to the claimed invention. The unit described by RU 173663 patent is installed after a wringing unit and is made in the form of a laying device for transverse strands of roving and in the form of n gears with holes that direct two longitudinal strands of roving, moreover, the gears interlocking with each other are mounted on a frame by means of shafts and are connected to an electric motor that drives them in rotary motion, moreover, the number of n gears is equal to the number of cells in one row of mesh.

The known design of the unit for forming and weaving mesh allows to interweave longitudinal and transverse strands of roving while creating mesh cells. However, a disadvantage of the known device is that it is impossible to create cells of equal size since it is impossible to feed transverse rods at a right angle. Moreover, since, obviously, there is a gap between interlocked gears' teeth of the known device, a large number of sequentially located gears interlocking with each other result in the fact that, when the leading gear is turning, each subsequent driven gear contributes to lost motion and is not fully turned, i.e. a clearance is formed in the row of gears, therefore, each subsequent gear increasingly fails to fully twist a longitudinal strand of roving. Thus, a disadvantage of the known unit, as well as of the previously mentioned analogue, is the low quality of final products due to nonuniform physical and mechanical characteristics of the entire web of finished non-metallic reinforcement mesh, as the result of the above reasons.

The technical result of the claimed invention is enhanced quality of produced non-metallic reinforcement mesh due to the possibility to ensure an equal number of twists of longitudinal strands of roving around a transverse rod positioned strictly perpendicular to them.

The technical result is achieved by the fact that the device for forming and weaving non-metallic reinforcing mesh that contains an electric drive, a transverse rod feeding unit, longitudinal bundle feeding unit (including gears with holes designed to divide the longitudinal bundle of roving into two longitudinal strands and to intertwist them), a cutting unit for the transverse rod (the feeding units and the cutting unit are mounted on a frame), in accordance with the invention, is equipped with a toothed rack and a guide comb that is located across the frame and that is capable to move along the axis and is equipped with a longitudinal groove for accommodating the transverse rod. Moreover, the toothed rack can reciprocate to drive the gears.

The device for forming and weaving non-metallic composite mesh contains a transverse rod alignment device located after the guide comb down the movement of mesh.

The introduction of a guide comb that can move along the axis (can tilt along the axis) and is equipped with a longitudinal groove allows to, while the guide comb is being lowered, feed the transverse rod from the transverse rod feeding unit through the above mentioned groove, the rod is fed strictly perpendicular to the longitudinal bundle of roving divided into two strands through the holes in the gears, moreover, the transverse rod is directed by the groove through the clearance between the two strands of each longitudinal rod without catching individual strands. The interweaving of the transverse rod with the longitudinal strands is performed after the guide comb has been raised at the moment when the transverse rod is maximally aligned. Therefore, even cells of non-metallic reinforcement mesh of equal size with strictly perpendicular transverse rods are formed.

In this case, the use of the toothed rack allows to make the gears rotate synchronously and to ensure the same number of gear rotations per cycle, which, in its turn, allows to achieve an equal number of twists of longitudinal strands of roving around the transverse rod at each cycle, which is impossible to achieve when gears are driven by a leading gear that is driven by an electric motor (as implemented in the closest analogue).

An equal number of twists of longitudinal strands of roving allows not only to achieve the same strength at all points of mesh interweaving, but also to minimize the possibility to displace a transverse rod from the position set by the guide comb since the force applied the transverse rod is equal at all points of interweaving.

The transverse rod alignment device located after the guide comb down the mesh movement allows for the final alignment of the transverse rods already installed and interwoven with longitudinal strands before feeding the mesh into a polymerization chamber.

Performed tests have shown that, as a result of using a prototype of the claimed device in a production line, non-metallic reinforcement composite mesh with transverse rods aligned throughout its web has been obtained, which affects performance characteristics of the mesh. For instance, the obtained mesh has the same tensile strength and the same adhesion to concrete over its entire web.

The essence of the claimed invention is explained by the figures:

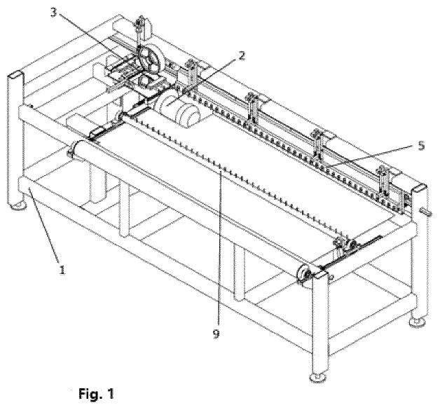

FIG. 1 schematically shows a general view of the device for forming and weaving non-metallic reinforcement mesh;

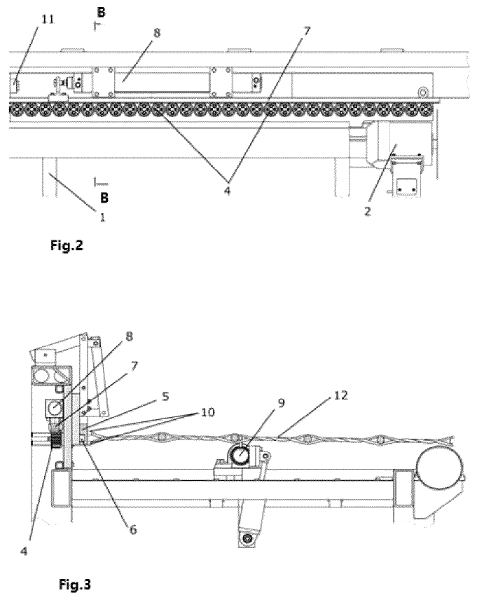

FIG. 2 schematically shows a view of a drive of gears for weaving longitudinal strands;

FIG. 3 schematically depicts B-B cross section of FIG. 2 which is a side view of the device for forming and weaving non-metallic reinforcing mesh.

The device for forming and weaving non-metallic reinforcing mesh (12) contains a frame (1), an electric drive (not shown in the drawings), a transverse rod feeding unit (3), a feeding unit for a longitudinal roving bundle that includes gears (4) with holes to separate the longitudinal bundle of roving into two strands, a cutting unit (2) for the transverse rod, a guide comb (5) with a longitudinal groove (6), gears (4) for intertwining longitudinal strands, the gears are interlocked with a toothed rack (7) that can be driven by a pneumatic cylinder (8), a transverse rod alignment device (9) that is located after the guide comb down the mesh movement.

Limiting the stroke of the pneumatic cylinder (8) that rotates gears (4) is ensured at each cycle by moving a stop (11) (a limiter of piston stroke), which allows to adjust the number of twists of longitudinal strands per cycle. The equal number of rotations makes it possible to bring the gears (4) back to their initial position. The gears can be equipped with tubes (10) that do not interfere with guide comb (5) pressing when the cycle is repeated, moreover, the tubes are positioned between the teeth of the guide comb when it is lowered.

The transverse rod alignment device (9) can be designed as a bar with protrusions that is positioned behind the device for weaving transverse to the longitudinal strands and that is made with a possibility of axial movement. The length of the toothed rack is sufficient to ensure an equal number of rotations of gears for intertwining longitudinal strands at each cycle. The toothed rack can be driven not only by a pneumatic cylinder, but also, for instance, by an electric motor, a chain-or belt-driven transmission, as well as by other types of drive.

The transverse rod feeding unit contains a pressure roller and a driving roller, and a carriage with holes that is able to move linearly in a longitudinal direction and to direct the transverse rod into the longitudinal groove of the guide comb. The holes of the gears may be equipped with guides that are positioned between the teeth of the guide comb when it is lowered, moreover, since longitudinal strands move along those guides, it is impossible to catch the transverse rod on the strands when it is being aligned.

Bobbins of roving are located on a bobbin rack. Roving threads pass through impregnation and wringing units where the roving is impregnated with compound, the excess compound is wringed at the unit's outlet. One impregnation and wringing unit is used for the transverse rod, the other two units are used for longitudinal rods. A unit for forming a spiral rib around the transverse rod is located behind the impregnation units. Roving passing through the unit is shaped to form transverse rod [symbol] with a spiral rib (periodic profile) around them. Then transverse rods enter a polymerization chamber where they are cured under the influence of temperature. Passing through the water cooling unit, the transverse rods enter a return wheel which reverses the direction of their movement. A transverse rod pulling unit ensures further continuous movement of the transverse rods. Passing through the pulling unit, the transverse rods get into a separator, which is a device designed for distribution, accumulation and feeding of transverse rods into the device for forming and weaving mesh. Roving for longitudinal rods passes through the impregnation and wringing units and then enters the device for forming and weaving mesh, bundles of longitudinal rods are formed there and are split into two strands when falling into the holes of the gears. The gears are designed with grooves between the holes, the transverse rod is directed into the grooves with two polyurethane-coated wheels. A cycle of forming and weaving of non-metallic reinforcement mesh in the claimed invention is performed in the following sequence: the guide comb is pressed down; a transverse rod is fed from the transverse rod feeding unit, the transverse rod is fixed and a saw mounted on a swing is directed to it and the transverse rod is cut, the guide comb is tilted freeing the transverse rod, the mesh is moving all the time, concurrently the pressure wheel is raised inside the feeding unit and the position of the feeding carriage is changed, the pressure wheel is lowered, the toothed rack drives the gears and weaving takes place.

The sequence of actions of the operating mechanisms is controlled by an algorithm incorporated in the electronic control program. In this case, the sequence of pneumatic cylinders movement is determined by actuation of the pneumatic distributor system resulted from the shifting of a spool (current from the control unit is applied to a solenoid which creates a magnetic field and moves the spool). Motor power control is carried out by applying current from a control unit to the motor, and the direction of motor rotation can be set by switching power terminals, whereas, the frequency of the motors is regulated by frequency converters in the control unit.

Later, nearly finished mesh enters the polymerization chamber where, under the influence of temperature, final curing takes place. A water cooling unit is used to cool the mesh.

The next step is cutting the mesh into measured lengths with an automatic cutting unit, the composite mesh is fed into the cutting unit through a pulling device that pulls roving and mesh through all functional mechanisms of the production line. To form rolls of mesh, a roll-forming device can be installed.

We claim

1. A device for forming and weaving non-metallic reinforcing mesh contains an electric drive and the following assembly units mounted on a frame: a transverse rod feeding unit, a longitudinal roving bundle feeding unit including gears with holes designed to divide a longitudinal roving bundle into two longitudinal strands and to intertwine them, as well as a transverse rod cutting unit. The device for forming and weaving non-metallic reinforcement mesh is characterized by the fact that it is equipped with a toothed rack and a guide comb. The guide comb is located across the frame, is made with a possibility of axial movement and is equipped with a longitudinal groove to accommodate the transverse rod. The toothed rack can reciprocate to drive the gears.

2. The device for forming and weaving non-metallic reinforcing mesh according to point 1 is characterized by the fact that is equipped with a device for aligning transverse rods which is positioned behind the guide comb down the mesh movement.
